(19) United States
(12) Patent Application Publication
(10) Pub. No.: US 2026/0099525 A1
(43) Pub. Date: Apr. 9, 2026

(54) SYSTEM AND METHOD FOR AUTOMATED STRUCTURE RETRIEVAL OF COMPLEX STANDARD OPERATING PROCEDURES

(71) Applicant: JPMorgan Chase Bank, N.A., New York, NY (US)

(72) Inventors: Deepeka GARG, London (GB); Leo ARDON, London (GB); Sumitra GANESH, Short Hills, NJ (US); Daniel BORRAJO, Pozuelo de Alarcon (ES); Annapoorani LAKSHMI NARAYANAN, New York, NY (US); Giuseppe CANONACO, Milano (IT)

(73) Assignee: JPMorgan Chase Bank, N.A., New York, NY (US)

(21) Appl. No.: 18/905,569

(22) Filed: Oct. 3, 2024

(51) Int. Cl. G06F 16/33; G06F 16/338

(52) U.S. Cl. CPC G06F 16/3344; G06F 16/338

(57) ABSTRACT

Various methods and processes, apparatuses/systems, and media for automated structure retrieval of complex standard operating procedures (SOPs) are disclosed. A processor encodes the SOP as a Directed Acyclic Graph (DAG) to keep track of the dependencies between SOP tasks or steps and retain the sequential aspect of the SOP execution. To be able to support long SOPs, the processor implements a multi-phase approach where the processor first performs a “segmentation” step to break the SOP into task segments which are then transformed into a DAG by calling a structure generation module. The segmentation is utilized recursively to attain a fined-grain decomposition of the SOP to facilitate effective DAG generation.

### TECHNICAL FIELD

This disclosure generally relates to data processing, and, more particularly, to methods and apparatuses for implementing a domain, platform, language, cloud, and database agnostic automated structure retrieval module configured for automated structure retrieval of complex standard operating procedures (SOPs).

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

SOP may provide a way for organizations to compile documents having step-by-step instructions that should be performed to carry out routine operations. These documents, typically written by Subject Matter Experts (SME), may constitute a crucial part of business knowledge, making the execution of procedures more efficient, uniform, and transferable between multiple team members. This type of knowledge may be often the effort of individuals describing their actions in natural language, with several iterations to ensure the document is as explicit as possible for anyone to follow.

There may be varying types of procedures, such as manuals and documentation on how to use systems, or standard work instructions for a particular process. Today, there appears to be no formalized process for creating operating procedures across teams and industries, so the format and information provided in these documents are at the discretion of the SMEs.

While an SOP may outline a very structured process, the description of this process may often remain largely unstructured. This lack of clear syntax or formalism typically makes it difficult to extract the natural sequence embedded in the SOP or to provide a clear way to interpret the information. Thus, these documents may be difficult to process by a machine, making it a challenge to leverage this information to automate workflows and empower humans with Artificial Intelligence (AI).

Although, Large Language Models (LLMs) have shown some promise for summarizing documents or understanding chat-like instructions, these models may still suffer from shortcomings when dealing with a long body of text where the task requires understanding in detail what each part is doing, as opposed to simply providing summarization. In addition, when a task requires structural understanding, with a sequence of steps and capturing dependencies among them, these LLMs and other conventional tools may fail to address challenges associated with complex SOPs featuring many tasks with a complex dependency structure.

### SUMMARY

The present disclosure, through one or more of its various aspects, embodiments, and/or specific features or sub-components, provides, among other features, various systems, servers, devices, methods, media, programs, and platforms for implementing a domain, platform, language, cloud, and database agnostic automated structure retrieval module configured to implement LLMs and classical planning technique to process complex SOPs to make them machine understandable and transform an unstructured document describing an arbitrarily long SOP, into a structured format defining the SOP steps as sub-tasks, their dependencies (interconnection between SOP steps), inputs, and outputs, composing the SOP, but the disclosure is not limited thereto. By standardizing the creation of SOPs and incorporating clear, machine-readable formats, organizations may better harness the power of AI to support human workers, enhancing their productivity and decision-making capabilities.

In some embodiments, a method for automated structure retrieval of complex SOPs by utilizing one or more processors along with allocated memory is disclosed. The method may include: implementing a model leveraging an LLM which receives, as input, an original SOP document, wherein the LLM breaks the original SOP document into a plurality of task segments; identifying starting and ending sentences of each task segment of said plurality of task segments by utilizing the LLM and thereby detecting context shifts and detecting boundaries between different tasks; deterministically extracting, in response to identifying, text from the original SOP document that falls within the detected boundaries thereby capturing information from the original SOP document within the task segments by leveraging the LLM's natural language understanding capabilities; transforming, in response to deterministically extracting, the task segments into a Directed Acyclic Graph (DAG) that includes a series of subtasks to keep track of dependencies between SOP tasks; validating the DAG by evaluating its attributes including: dependency accuracy, dependency output alignment, DAG connectivity, input accuracy, and output accuracy; and automatically outputting, in response to validating, a structured SOP document corresponding to the DAG, confirms that the dependencies in the subtasks are correctly captured, and confirms an alignment between initial and goal states of the structured SOP document and the original SOP document.

In some embodiments, each subtask may be represented as a node of the DAG, and dependencies between the subtasks may be represented as links or edges between the nodes.

In some embodiments, the method may further include: outputting, for each of said subtasks, a corresponding category identifying corresponding type of each of said subtasks whether a subtask is a decision step, an action to execute, or domain specific knowledge.

In some embodiments, in validating the DAG by evaluating the dependency accuracy attribute, the method may further include: comparing an input of each subtask with its list of dependencies.

In some embodiments, the method may further include: validating the DAG when it is determined, based on comparing, that the input originates from a subtask that is listed as a dependency.

In some embodiments, the method may further include: invalidating the DAG when it is determined, based on comparing, that the input originates from a subtask that is not listed as a dependency.

In some embodiments, in validating the DAG by evaluating the dependency output alignment attribute, the method may further include: comparing inputs required by each subtask with outputs generated by other subtasks.

In some embodiments, the method may further include: validating the DAG when it is determined, based on comparing, that suitable mapping exists between the inputs and the outputs.

In some embodiments, the method may further include: invalidating the DAG when it is determined, based on comparing, that no suitable mapping exists between the inputs and the outputs.

In some embodiments, in validating the DAG by evaluating the DAG connectivity attribute, the method may further include: traversing DAG, by implementing a classical planning technique, to verify that there exists a path between the initial state and the goal state within the DAG.

In some embodiments, in validating the DAG by evaluating the input accuracy attribute, the method may further include: comparing input information of the DAG with input information specified in the original SOP document.

In some embodiments, the method may further include: validating the DAG when it is determined, based on comparing, that the input information of the DAG accurately reflects the input information specified in the original SOP document.

In some embodiments, the method may further include: invalidating the DAG when it is determined, based on comparing, that the input information of the DAG does not accurately reflect the input information specified in the original SOP document.

In some embodiments, in validating the DAG by evaluating the output accuracy attribute, the method may further include: comparing output information generated by the DAG with output information specified in the original SOP document.

In some embodiments, the method may further include: validating the DAG when it is determined, based on comparing, that the output information generated by the DAG accurately reflects the output information specified in the original SOP document.

In some embodiments, the method may further include: invalidating the DAG when it is determined, based on comparing, that the output information generated by the DAG does not accurately reflect the output information specified in the original SOP document.

In some embodiments, a system for automated structure retrieval of complex SOPs is disclosed. The system may include: a processor; and a memory operatively connected to the processor via a communication interface, the memory storing computer readable instructions, when executed, may cause the processor to: implement a model leveraging an LLM which receives, as input, an original SOP document, wherein the LLM breaks the original SOP document into a plurality of task segments; identify starting and ending sentences of each task segment of said plurality of task segments by utilizing the LLM and thereby detecting context shifts and detecting boundaries between different tasks; deterministically extract, in response to identifying, text from the original SOP document that falls within the detected boundaries thereby capturing information from the original SOP document within the task segments by leveraging the LLM's natural language understanding capabilities; transform, in response to deterministically extracting, the task segments into a DAG that includes a series of subtasks to keep track of dependencies between SOP tasks; validate the DAG by evaluating its attributes including: dependency accuracy, dependency output alignment, DAG connectivity, input accuracy, and output accuracy; and automatically output, in response to validating, a structured SOP document corresponding to the DAG, confirms that the dependencies in the subtasks are correctly captured, and confirms an alignment between initial and goal states of the structured SOP document and the original SOP document.

In some embodiments, the processor may be further configured to: output, for each of said subtasks, a corresponding category identifying corresponding type of each of said subtasks whether a subtask is a decision step, an action to execute, or domain specific knowledge.

In some embodiments, in validating the DAG by evaluating the dependency accuracy attribute, the processor may be further configured to: compare an input of each subtask with its list of dependencies.

In some embodiments, the processor may be further configured to: validate the DAG when it is determined, based on comparing, that the input originates from a subtask that is listed as a dependency.

In some embodiments, the processor may be further configured to: invalidate the DAG when it is determined, based on comparing, that the input originates from a subtask that is not listed as a dependency.

In some embodiments, in validating the DAG by evaluating the dependency output alignment attribute, the processor may be further configured to: compare inputs required by each subtask with outputs generated by other subtasks.

In some embodiments, the processor may be further configured to: validate the DAG when it is determined, based on comparing, that suitable mapping exists between the inputs and the outputs.

In some embodiments, the processor may be further configured to: invalidate the DAG when it is determined, based on comparing, that no suitable mapping exists between the inputs and the outputs.

In some embodiments, in validating the DAG by evaluating the DAG connectivity attribute, the processor may be further configured to: traverse DAG, by implementing a classical planning technique, to verify that there exists a path between the initial state and the goal state within the DAG.

In some embodiments, in validating the DAG by evaluating the input accuracy attribute, the processor may be further configured to: compare input information of the DAG with input information specified in the original SOP document.

In some embodiments, the processor may be further configured to: validate the DAG when it is determined, based on comparing, that the input information of the DAG accurately reflects the input information specified in the original SOP document.

In some embodiments, the processor may be further configured to: invalidate the DAG when it is determined, based on comparing, that the input information of the DAG does not accurately reflect the input information specified in the original SOP document.

In some embodiments, in validating the DAG by evaluating the output accuracy attribute, the processor may be further configured to: compare output information generated by the DAG with output information specified in the original SOP document.

In some embodiments, the processor may be further configured to: validate the DAG when it is determined, based on comparing, that the output information generated by the DAG accurately reflects the output information specified in the original SOP document.

In some embodiments, the processor may be further configured to: invalidate the DAG when it is determined, based on comparing, that the output information generated by the DAG does not accurately reflect the output information specified in the original SOP document.

In some embodiments, a non-transitory computer readable medium configured to store instructions for automated structure retrieval of complex SOPs is disclosed. The instructions, when executed, may cause a processor to perform the following: implementing a model leveraging an LLM which receives, as input, an original SOP document, wherein the LLM breaks the original SOP document into a plurality of task segments; identifying starting and ending sentences of each task segment of said plurality of task segments by utilizing the LLM and thereby detecting context shifts and detecting boundaries between different tasks; deterministically extracting, in response to identifying, text from the original SOP document that falls within the detected boundaries thereby capturing information from the original SOP document within the task segments by leveraging the LLM's natural language understanding capabilities; transforming, in response to deterministically extracting, the task segments into a DAG that includes a series of subtasks to keep track of dependencies between SOP tasks; validating the DAG by evaluating its attributes including: dependency accuracy, dependency output alignment, DAG connectivity, input accuracy, and output accuracy; and automatically outputting, in response to validating, a structured SOP document corresponding to the DAG, confirms that the dependencies in the subtasks are correctly captured, and confirms an alignment between initial and goal states of the structured SOP document and the original SOP document.

In some embodiments, the instructions, when executed, may cause the processor to further perform the following: outputting, for each of said subtasks, a corresponding category identifying corresponding type of each of said subtasks whether a subtask is a decision step, an action to execute, or domain specific knowledge.

In some embodiments, in validating the DAG by evaluating the dependency accuracy attribute, the instructions, when executed, may cause the processor to further perform the following: comparing an input of each subtask with its list of dependencies.

In some embodiments, the instructions, when executed, may cause the processor to further perform the following: validating the DAG when it is determined, based on comparing, that the input originates from a subtask that is listed as a dependency.

In some embodiments, the instructions, when executed, may cause the processor to further perform the following: invalidating the DAG when it is determined, based on comparing, that the input originates from a subtask that is not listed as a dependency.

In some embodiments, in validating the DAG by evaluating the dependency output alignment attribute, the instructions, when executed, may cause the processor to further perform the following: comparing inputs required by each subtask with outputs generated by other subtasks.

In some embodiments, the instructions, when executed, may cause the processor to further perform the following: validating the DAG when it is determined, based on comparing, that suitable mapping exists between the inputs and the outputs.

In some embodiments, the instructions, when executed, may cause the processor to further perform the following: invalidating the DAG when it is determined, based on comparing, that no suitable mapping exists between the inputs and the outputs.

In some embodiments, in validating the DAG by evaluating the DAG connectivity attribute, the instructions, when executed, may cause the processor to further perform the following: traversing DAG, by implementing a classical planning technique, to verify that there exists a path between the initial state and the goal state within the DAG.

In some embodiments, in validating the DAG by evaluating the input accuracy attribute, the instructions, when executed, may cause the processor to further perform the following: comparing input information of the DAG with input information specified in the original SOP document.

In some embodiments, the instructions, when executed, may cause the processor to further perform the following: validating the DAG when it is determined, based on comparing, that the input information of the DAG accurately reflects the input information specified in the original SOP document.

In some embodiments, the instructions, when executed, may cause the processor to further perform the following: invalidating the DAG when it is determined, based on comparing, that the input information of the DAG does not accurately reflect the input information specified in the original SOP document.

In some embodiments, in validating the DAG by evaluating the output accuracy attribute, the instructions, when executed, may cause the processor to further perform the following: comparing output information generated by the DAG with output information specified in the original SOP document.

In some embodiments, the instructions, when executed, may cause the processor to further perform the following: validating the DAG when it is determined, based on comparing, that the output information generated by the DAG accurately reflects the output information specified in the original SOP document.

In some embodiments, the instructions, when executed, may cause the processor to further perform the following: invalidating the DAG when it is determined, based on comparing, that the output information generated by the DAG does not accurately reflect the output information specified in the original SOP document.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated structure retrieval module configured to transform an unstructured document describing an arbitrarily long SOP into a structured format defining the SOP steps as sub-tasks, their dependencies (interconnection between SOP steps), inputs, and outputs, composing the SOP in accordance with an embodiment.

FIG. 2 illustrates a diagram of a network environment with a platform, language, database, and cloud agnostic automated structure retrieval device in accordance with an embodiment.

FIG. 3 illustrates a system diagram for implementing a platform, language, database, and cloud agnostic automated structure retrieval device having a platform, language, database, and cloud agnostic automated structure retrieval module in accordance with an embodiment.

FIG. 4 illustrates a system diagram for implementing a platform, language, database, and cloud agnostic automated structure retrieval module of FIG. 3 in accordance with an embodiment.

FIG. 5 illustrates an architecture diagram for structured SOP generation as implemented by the platform, language, database, and cloud agnostic automated structure retrieval module of FIG. 4 in accordance with an embodiment.

FIG. 6 illustrates a flow chart of a process implemented by the platform, language, database, and cloud agnostic automated structure retrieval module of FIG. 4 for transforming an unstructured document describing an arbitrarily long SOP into a structured format defining the SOP steps as sub-tasks, their dependencies (interconnection between SOP steps), inputs, and outputs, composing the SOP in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, while an SOP may outline a very structured process, the description of this process may often remain largely unstructured. This lack of clear syntax or formalism typically makes it difficult to extract the natural sequence embedded in the SOP or to provide a clear way to interpret the information. Thus, these documents may be difficult to process by a machine, making it a challenge to leverage this information to automate workflows and empower humans with AI.

Moreover, as mentioned earlier, although, LLMs have shown some promise for summarizing documents or understanding chat-like instructions, these models may still suffer from shortcomings when dealing with a long body of text where the task requires understanding in detail what each part is doing, as opposed to simply providing summarization. In addition, when a task requires structural understanding, with a sequence of steps and capturing dependencies among them, these LLMs and other conventional tools may fail to address challenges associated with complex SOPs featuring many tasks with a complex dependency structure.

To address the above-noted technical problems associated with conventional tools, the present disclosure, through one or more of its various aspects, embodiments, and/or specific features or sub-components, provides, among other features, various systems, servers, devices, methods, media, programs, and platforms for implementing a domain, platform, language, cloud, and database agnostic automated structure retrieval module configured to implement LLMs and classical planning technique to process complex SOPs to make them machine understandable and transform an unstructured document describing an arbitrarily long SOP, into a structured format defining the SOP steps as sub-tasks, their dependencies (interconnection between SOP steps), inputs, and outputs, composing the SOP but the disclosure is not limited thereto. By standardizing the creation of SOPs and incorporating clear, machine-readable formats, organizations may better harness the power of AI to support human workers, enhancing their productivity and decision-making capabilities.

For example, the automated structure retrieval module as disclosed herein may be configured to encode the SOP as a DAG to keep track of the dependencies between SOP tasks or steps and retain the sequential aspect of the SOP execution. To be able to support long SOPs, the automated structure retrieval module as disclosed herein may employ a multi-phase approach where the automated structure retrieval module first performs a “segmentation” step to break the SOP into task segments which are then transformed into a DAG by calling a structure generation module via a corresponding application programming interface. This segmentation step may be used recursively to attain a fined-grain decomposition of the SOP to facilitate effective DAG generation, but the disclosure is not limited thereto.

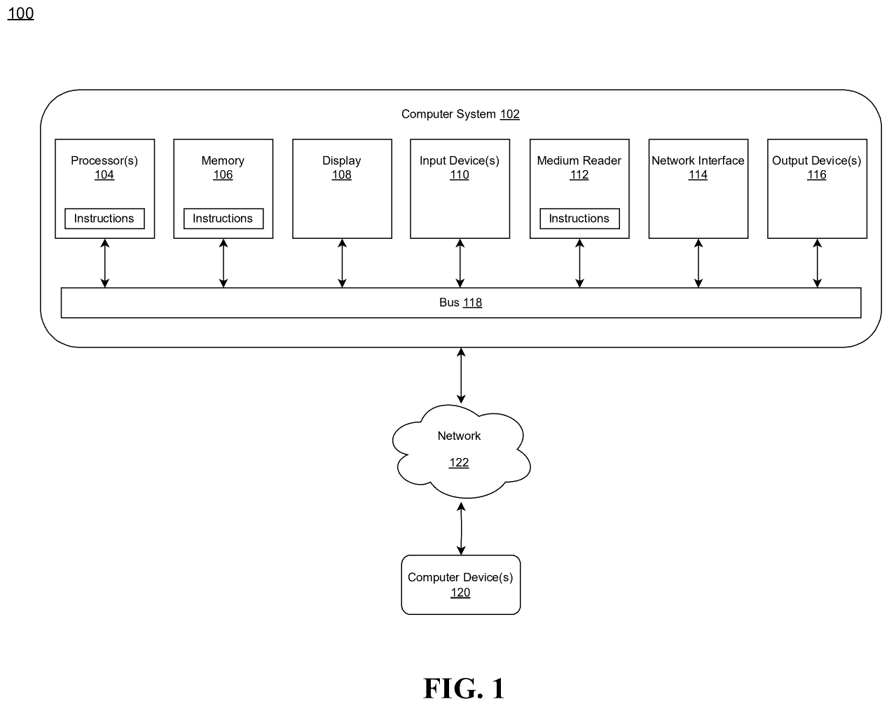

FIG. 1 is an exemplary system 100 for use in implementing a platform, language, database, and cloud agnostic automated structure retrieval module configured to transform an unstructured document describing an arbitrarily long SOP into a structured format defining the SOP steps as sub-tasks, their dependencies (interconnection between SOP steps), inputs, and outputs, composing the SOP in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated structure retrieval module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the automated structure retrieval module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

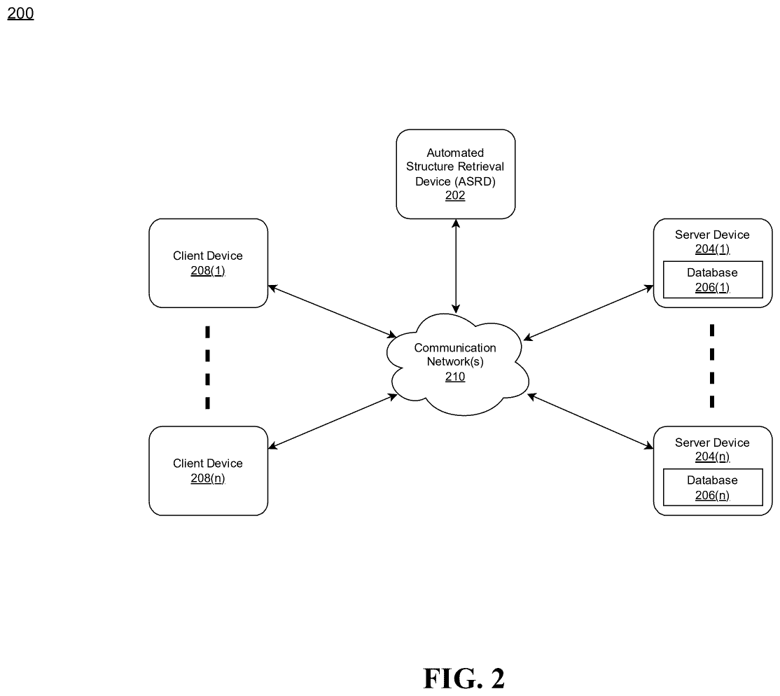

Referring to FIG. 2, a schematic of an exemplary network environment 200 for implementing a language, platform, database, and cloud agnostic automated structure retrieval device (ASRD) of the instant disclosure is illustrated.

In some embodiments, the above-described problems associated with conventional tools may be overcome by implementing an ASRD 202 as illustrated in FIG. 2 that may be configured for implementing a platform, language, database, and cloud agnostic automated structure retrieval module configured to transform an unstructured document describing an arbitrarily long SOP into a structured format defining the SOP steps as sub-tasks, their dependencies (interconnection between SOP steps), inputs, and outputs, composing the SOP, but the disclosure is not limited thereto.

The ASRD 202 may have one or more computer system 102s, as described with respect to FIG. 1, which in aggregate provide the necessary functions.

The ASRD 202 may store one or more applications that may include executable instructions that, when executed by the ASRD 202, cause the ASRD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ASRD 202 itself, may be located in virtual server(s) running in a cloud-based computing environment rather than being tied to one or more specific physical network computing devices. Also, the application(s) may be running in one or more virtual machines (VMs) executing on the ASRD 202. Additionally, in one or more embodiments of this technology, virtual machine(s) running on the ASRD 202 may be managed or supervised by a hypervisor.

In the network environment 200 of FIG. 2, the ASRD 202 may be coupled to a plurality of server devices 204(1)-204(n) that hosts a plurality of databases 206(1)-206(n), and also to a plurality of client devices 208(1)-208(n) via communication network(s) 210. A communication interface of the ASRD 202, such as the network interface 114 of the computer system 102 of FIG. 1, operatively couples and communicates between the ASRD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ASRD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ASRD 202 may be a standalone device or integrated with one or more other devices or apparatuses, such as one or more of the server devices 204(1)-204(n). In some embodiments, the ASRD 202 may be hosted by one of the server devices 204(1)-204(n), and other arrangements may also be possible. Moreover, one or more of the devices of the ASRD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ASRD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ASRD 202 that may efficiently provide a platform for implementing a platform, language, database, and cloud agnostic automated structure retrieval module configured to transform an unstructured document describing an arbitrarily long SOP into a structured format defining the SOP steps as sub-tasks, their dependencies (interconnection between SOP steps), inputs, and outputs, composing the SOP, but the disclosure is not limited thereto.

The client devices 208(1)-208(n) may run interface applications, such as standard web browsers or standalone client applications, which may provide an interface to communicate with the ASRD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ASRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ASRD 202, the server devices 204(1)-204(n), or the client devices 208(1)-208(n), in some embodiments, may be configured to operate as virtual instances on the same physical machine. In some embodiments, one or more of the ASRD 202, the server devices 204(1)-204(n), or the client devices 208(1)-208(n) may operate on the same physical device rather than as separate devices communicating through communication network(s) 210. Additionally, there may be more or fewer ASRDs 202, server devices 204(1)-204(n), or client devices 208(1)-208(n) than illustrated in FIG. 2. In some embodiments, the ASRD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

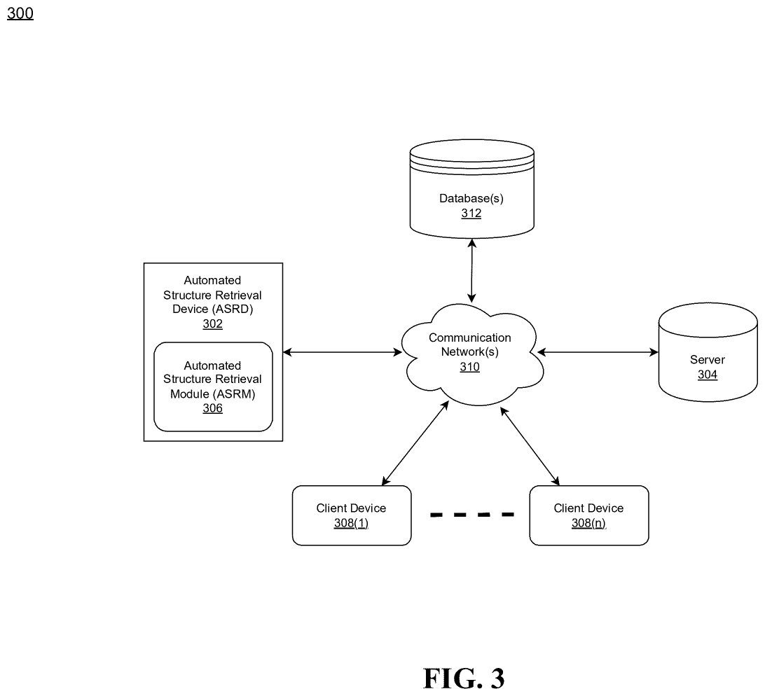

FIG. 3 illustrates a system diagram for implementing a platform, language, and cloud agnostic ASRD having a platform, language, database, and cloud agnostic automated structure retrieval module (ASRM) in accordance with an embodiment.

As illustrated in FIG. 3, the system 300 may include an ASRD 302 within which an ASRM 306 may be embedded, a server 304, a database(s) 312, a plurality of client devices 308(1) . . . 308(n), and a communication network 310.

In some embodiments, the ASRD 302 including the ASRM 306 may be connected to the server 304, and the database(s) 312 via the communication network 310. The ASRD 302 may also be connected to the plurality of client devices 308(1) . . . 308(n) via the communication network 310, but the disclosure is not limited thereto.

According to exemplary embodiment, the ASRD 302 is described and shown in FIG. 3 as including the ASRM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the ASRM 306 may be configured to receive real-time feed of data from the plurality of client devices 308(1) . . . 308(n) and secondary sources via the communication network 310.

As may be described below, the ASRM 306 may be configured to: implement a model leveraging an LLM which receives, as input, an original SOP document, wherein the LLM breaks the original SOP document into a plurality of task segments; identify starting and ending sentences of each task segment of said plurality of task segments by utilizing the LLM and thereby detecting context shifts and detecting boundaries between different tasks; deterministically extract, in response to identifying, text from the original SOP document that falls within the detected boundaries thereby capturing information from the original SOP document within the task segments by leveraging the LLM's natural language understanding capabilities; transform, in response to deterministically extracting, the task segments into a DAG that includes a series of subtasks to keep track of dependencies between SOP tasks; validate the DAG by evaluating its attributes including: dependency accuracy, dependency output alignment, DAG connectivity, input accuracy, and output accuracy; and automatically output, in response to validating, a structured SOP document corresponding to the DAG, confirms that the dependencies in the subtasks are correctly captured, and confirms an alignment between initial and goal states of the structured SOP document and the original SOP document, but the disclosure is not limited thereto.

The plurality of client devices 308(1) . . . 308(n) are illustrated as being in communication with the ASRD 302. In this regard, the plurality of client devices 308(1) . . . 308(n) may be “clients” (e.g., customers) of the ASRD 302 and are described herein as such. Nevertheless, it is to be known and understood that the plurality of client devices 308(1) . . . 308(n) need not necessarily be “clients” of the ASRD 302, or any entity described in association therewith herein. Any additional or alternative relationship may exist between either or both of the plurality of client devices 308(1) . . . 308(n) and the ASRD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ASRD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ASRD 302 may be the same or similar to the ASRD 202 as described with respect to FIG. 2, including any features or combination of features described with respect thereto.

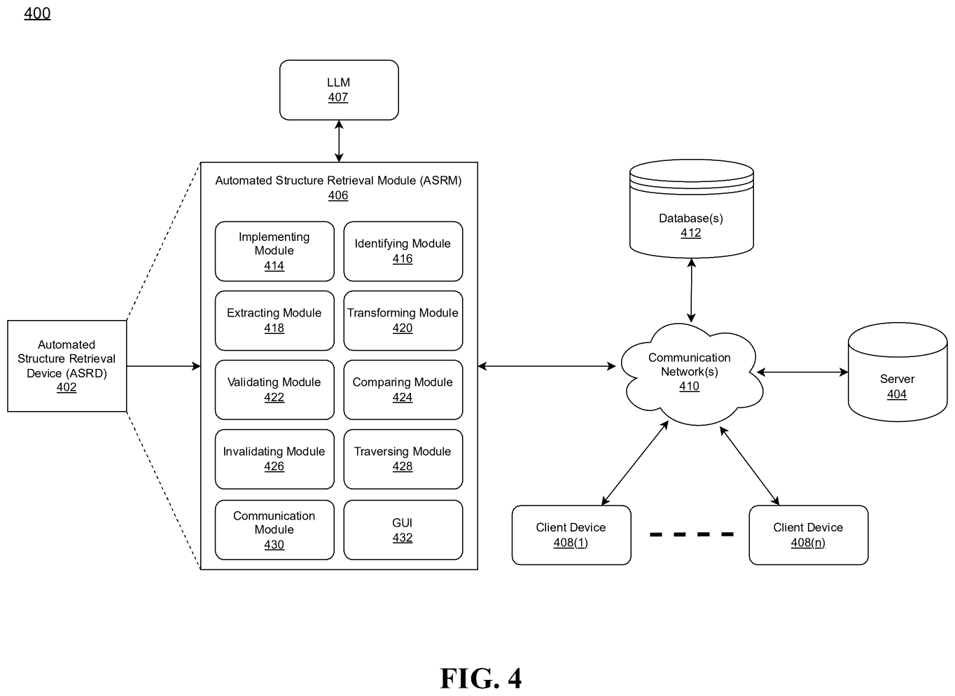

FIG. 4 illustrates a system diagram for implementing a platform, language, database, and cloud agnostic ASRM of FIG. 3 in accordance with an exemplary embodiment.

In some embodiments, the system 400 may include a platform, language, database, and cloud agnostic ASRD 402 within which a platform, language, database, and cloud agnostic ASRM 406 may be embedded, a server 404, database(s) 412, an LLM 407, and a communication network 410. In some embodiments, server 404 may comprise a plurality of servers located centrally or located in different locations, but the disclosure is not limited thereto.

In some embodiments, the ASRD 402 including the ASRM 406 may be connected to the server 404, the LLM 407, and the database(s) 412 via the communication network 410. The ASRD 402 may also be connected to the plurality of client devices 408(1)-408(n) via the communication network 410, but the disclosure is not limited thereto. The ASRM 406, the server 404, the plurality of client devices 408(1)-408(n), the database(s) 412, the communication network 410 as illustrated in FIG. 4 may be the same or similar to the ASRM 306, the server 304, the plurality of client devices 308(1)-308(n), the database(s) 312, the communication network 310, respectively, as illustrated in FIG. 3.

In some embodiments, as illustrated in FIG. 4, the ASRM 406 may include an implementing module 414, an identifying module 416, an extracting module 418, a transforming module 420, a validating module 422, a comparing module 424, an invalidating module 426, a traversing module 428, a communication module 430, and a Graphical User Interface (GUI). In some embodiments, interactions and data exchange among these modules included in the ASRM 406 provide the advantageous effects of the disclosed invention. Functionalities of each module of FIG. 4 may be described in detail below with reference to FIGS. 4-6.

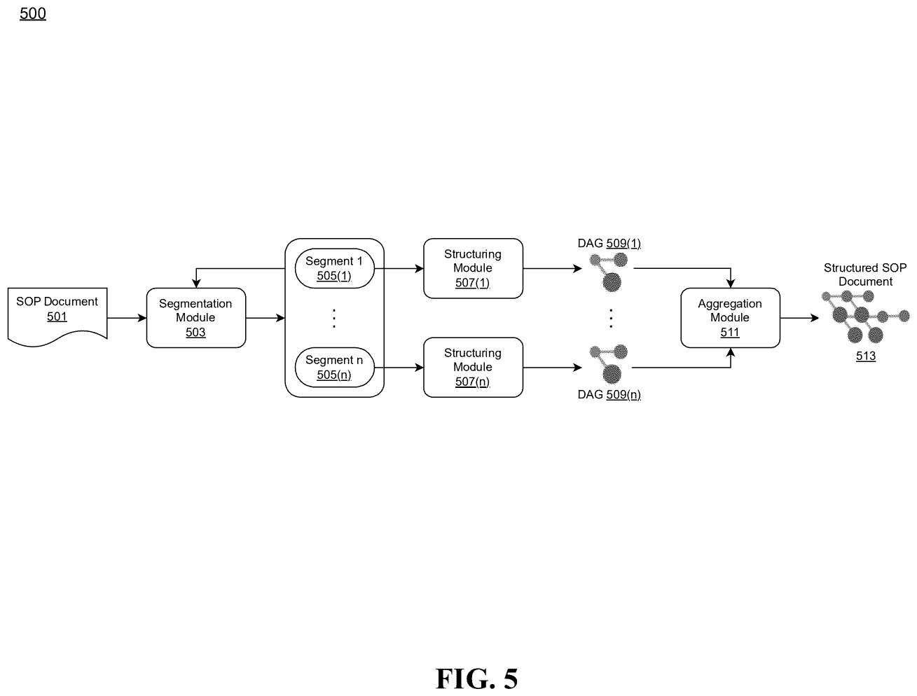

FIG. 5 illustrates an architecture diagram 500 for structured SOP generation as implemented by the ASRM 406 of FIG. 4 in accordance with an embodiment. As illustrated in FIG. 5, a segmentation module 503 may receive an SOP document 501 as input. The segmentation module 503 may leverage an LLM to recognize task segments, i.e., segment 1 505(1)-segment n 505(n), within the SOP document. The segmentation module 503 may utilize an LLM to analyze the SOP and identify the starting and ending sentences of each task segment. LLM's natural language understanding capabilities allow it to detect context shifts and boundaries between different tasks. Once the starting and ending sentences for each segment are identified, ASRM 406 may deterministically extract the text from the SOP that falls within these boundaries. This ensures that all relevant information from the SOP is captured accurately within the task segments, i.e., segment 1 505(1)-segment n 505(n)

In some embodiments, each structuring module 507((1)-507(n) may receive segment 1 505(1)-segment n 505(n), respectively, as input and may leverage an LLM to decompose the SOP into a series of subtasks, producing a corresponding a DAG 509(1)-509(n), respectively. Each subtask may be represented as a node/vertex of the DAG 509(1)-509(n), and dependencies between the subtasks may be represented as links/edges between the nodes. Through the execution of topological sorting of subtasks, the entire SOP may be executed in the correct order. For example, the aggregation module 511 may receive each DAG 509(1)-509(n) as input, and output a structured SOP document 513.

Referring back to FIGS. 4 and 5, in some embodiments, each of the implementing module 414, identifying module 416, extracting module 418, transforming module 420, validating module 422, comparing module 424, invalidating module 426, traversing module 428, and the communication module 430 of the ASRM 406 of FIG. 4, and the segmentation module 503, structuring module 507(1)-507(n), and the aggregation module 511 of FIG. 5 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the implementing module 414, identifying module 416, extracting module 418, transforming module 420, validating module 422, comparing module 424, invalidating module 426, traversing module 428, and the communication module 430 of the ASRM 406 of FIG. 4, and the segmentation module 503, structuring module 507(1)-507(n), and the aggregation module 511 of FIG. 5 may be implemented by microprocessors or similar, and may be programmed using software (e.g., microcode) to perform various functions discussed herein and may optionally be driven by firmware and/or software.

Alternatively, in some embodiments, each of the implementing module 414, identifying module 416, extracting module 418, transforming module 420, validating module 422, comparing module 424, invalidating module 426, traversing module 428, and the communication module 430 of the ASRM 406 of FIG. 4, and the segmentation module 503, structuring module 507(1)-507(n), and the aggregation module 511 of FIG. 5 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ASRM 406 of FIG. 4 may also be implemented by Cloud based deployment.

In some embodiments, each of the implementing module 414, identifying module 416, extracting module 418, transforming module 420, validating module 422, comparing module 424, invalidating module 426, traversing module 428, and the communication module 430 of the ASRM 406 of FIG. 4, and the segmentation module 503, structuring module 507(1)-507(n), and the aggregation module 511 of FIG. 5 may be called via corresponding API, but the disclosure is not limited thereto. For example, the implementing module 414 may be called via a first API, identifying module 416 may be called via a second API, extracting module 418 may be called via a third API, transforming module 420 may be called via a fourth API, validating module 422 may be called via a fifth API, comparing module 424 may be called via a sixth API, invalidating module 426 may be called via a seventh API, traversing module 428 may be called via an eighth API, the communication module 430 may be called via a ninth API, the segmentation module 50 may be called via a tenth API 3, each of the structuring module 507(1)-507(n) may be called via corresponding eleventh API, and the aggregation module 511 may be called via a twelfth API. In some embodiments, calls may also be made using event based message interfaces in addition to APIs.

In some embodiments, the process implemented by the ASRM 406 may be executed via the communication module 430, the communication channels 403, and the communication network 410, which may comprise plural networks as described above. In some embodiments, in an exemplary embodiment, the various components of the ASRM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

Referring back to FIGS. 4 and 5, in some embodiments, the implementing module 414 may be configured to implement a model leveraging an LLM 407 which receives, as input, an original SOP document 501, wherein the LLM 407 breaks the original SOP document into a plurality of task segments segment 1 505(1)-segment n 505(n) by utilizing the segmentation module 503.

In some embodiments, the identifying module 416 may be configured to identify starting and ending sentences of each task segment of the plurality of task segments segment 1 505(1)-segment n 505(n) by utilizing the LLM 407 and thereby detecting context shifts and detecting boundaries between different tasks.

In some embodiments, the extracting module 418 may be configured to deterministically extract, in response to identifying, text from the original SOP document 501 that falls within the detected boundaries thereby capturing all relevant information from the original SOP document 501 within the task segments segment 1 505(1)-segment n 505(n) by leveraging the LLM's 407 natural language understanding capabilities.

In some embodiments, the transforming module 420 may be configured to transform, in response to deterministically extracting, the task segments into a corresponding DAG, i.e., 509(1)-509(n), that includes a series of subtasks to keep track of dependencies between SOP tasks or steps and retain sequential aspect of the SOP execution.

In some embodiments, the validating module 422 may be configured to validate the DAG 509(1)-509(n) by evaluating the following attributes: dependency accuracy, dependency output alignment, DAG connectivity, input accuracy, and output accuracy; and automatically output onto the GUI 432, in response to validating, a structured SOP document 513 corresponding to the DAG 509(1)-509(n), confirms that the dependencies in the subtasks are correctly captured, and confirms an alignment between initial and goal states of the structured SOP document 513 and the original SOP document 501.

In some embodiments, each subtask may be represented as a node of the corresponding DAG 509(1)-509(n), and dependencies between the subtasks may be represented as links or edges between the nodes.

In some embodiments, the ASRM 406 may be configured to output onto the GUI 432, for each of the subtasks, a corresponding category identifying corresponding type of each of the subtasks whether a subtask is a decision step, an action to execute, or domain specific knowledge.

In some embodiments, in validating the DAG 509(1)-509(n) by evaluating the dependency accuracy attribute, the comparing module 424 may be configured to compare an input of each subtask with its list of dependencies.

In some embodiments, the validating module 422 may be further configured to validate the DAG 509(1)-509(n) when it is determined, based on comparing by the comparing module 424, that the input originates from a subtask that is listed as a dependency.

In some embodiments, the invalidating module 426 may be configured to invalidate the DAG 509(1)-509(n) when it is determined, based on comparing by the comparing module 424, that the input originates from a subtask that is not listed as a dependency.

In some embodiments, in validating the DAG 509(1)-509(n) by evaluating the dependency output alignment attribute, the comparing module 424 may be configured to compare inputs required by each subtask with outputs generated by other subtasks.

In some embodiments, the validating module 422 may be configured to validate the DAG 509(1)-509(n) when it is determined, based on comparing, that suitable mapping exists between the inputs and the outputs.

In some embodiments, the invalidating module 426 may be configured to invalidate the DAG 509(1)-509(n) when it is determined, based on comparing, that no suitable mapping exists between the inputs and the outputs.

In some embodiments, in validating the DAG 509(1)-509(n) by evaluating the DAG 509(1)-509(n) connectivity attribute, the traversing module may be configured to traverse the DAG 509(1)-509(n), by implementing a classical planning technique, to verify that there exists a path between the initial state and the goal state within the DAG 509(1)-509(n).

In some embodiments, in validating the DAG 509(1)-509(n) by evaluating the input accuracy attribute, the comparing module 424 may be configured to compare input information of the DAG 509(1)-509(n) with input information specified in the original SOP document 501.

In some embodiments, the validating module 422 may be configured to validate the DAG 509(1)-509(n) when it is determined, based on comparing by the comparing module 424, that the input information of the DAG 509(1)-509(n) accurately reflects the input information specified in the original SOP document 501.

In some embodiments, the invalidating module 426 may be configured to invalidate the DAG 509(1)-509(n) when it is determined, based on comparing by the comparing module 424, that the input information of the DAG 509(1)-509(n) does not accurately reflect the input information specified in the original SOP document 501.

In some embodiments, in validating the DAG 509(1)-509(n) by evaluating the output accuracy attribute, the comparing module 424 may be configured to compare output information generated by the DAG 509(1)-509(n) with output information specified in the original SOP document 501.

In some embodiments, the validating module 422 may be configured to validate the DAG 509(1)-509(n) when it is determined, based on comparing by the comparing module 424, that the output information generated by the DAG 509(1)-509(n) accurately reflects the output information specified in the original SOP document 501.

In some embodiments, the invalidating module 426 may be configured to invalidate the DAG 509(1)-509(n) when it is determined, based on comparing by the comparing module 424, that the output information generated by the DAG 509(1)-509(n) does not accurately reflect the output information specified in the original SOP document 501.

In some embodiments, each of the structuring module 507(1)-507(n) may generate the DAG 509(1)-509(n) of the SOP in JSON format, ensuring that each step of the SOP or subtask within the DAG 509(1)-509(n) is treated as an atomic operation. In creating the DAG 509(1)-509(n), names, descriptions, and dependencies for each node may be specified. In creating the DAG 509(1)-509(n), the variables may be generated by each subtask so that these variables may be referenced as inputs for subsequent subtasks. This may result in a clearly defined graph connectivity, where it may be easy to identify which SOP step's output is utilized by the following parts of the SOP. For each of the subtasks, the methodology implemented by the ASRM 406 may output a property called category identifying the type of this subtask: whether it is a decision step, an action to execute, or domain specific knowledge. This extra information may provide a richer encoding of the SOP. An exemplary pseudo cade may include the following:

{
“name”: . . . ,
“description”: . . . ,
“dependency”: [. . . ],
“input_from_dependency”: {. . . }
“input”: { },
“output”: [. . . ],
“category”: . . .
   }

In some embodiments, input accuracy and output accuracy may require semantic understanding of the instructions to identify the initial and goal states accurately. The initial state and goal state may be statically retrieved from the DAG 509(1)-509(n) for evaluation, ensuring they match those specified in the SOP.

In some embodiments, the ASRM 406 may leverage a planner to test the connectivity of the DAG 509(1)-509(n) based on its dependency structure. The ASRM 406 may utilize an encoding language, i.e., Planning Domain Definition Language (PDDL), for “classical” planning tasks. The domain definition of an exemplary meta-planning problem may encode the following predicates and actions that may be executed by the ASRM: execute-subtask: execute a subtask if the required inputs are available and make available a new set of variables characterizing the subtask's output. assign: map a variable with one name to a new variable with another name. This may prove to be useful when the name of an input is different from the name of the output of the dependency.

In some embodiments, the following predicates may be used by the ASRM 406:

available: indicates whether a variable is available for use.
required-input: indicates that a variable must be available for a subtask to be executed.
subtask-effect: indicates that a given variable will be made available once the subtask is executed.
map: indicates a mapping between 2 variables.

While the domain remains fixed, the ASRM 406, in an embodiment, may automatically generate a new instance of the problem (i.e., a new task) to solve for each structured SOP (i.e., structured SOP document 513 as illustrated in FIG. 5), that needs to be evaluated. By going through the structured SOP generated, the ASRM 406 may be configured to extract the necessary components to encode the task. For example, “objects” may correspond to all the subtasks and variables objects that may be used to solve the problem; “init variables” may correspond to the variables that are not coming from any dependencies and therefore are assumed to compose the initial state of the problem; “required inputs” may correspond to the set of variables that may be required to execute a subtask; “subtask effects” may correspond to the set of variables that may be made available once the subtask is executed; and “goal” may correspond to the outputs of all the subtasks, but the disclosure is not limited thereto.

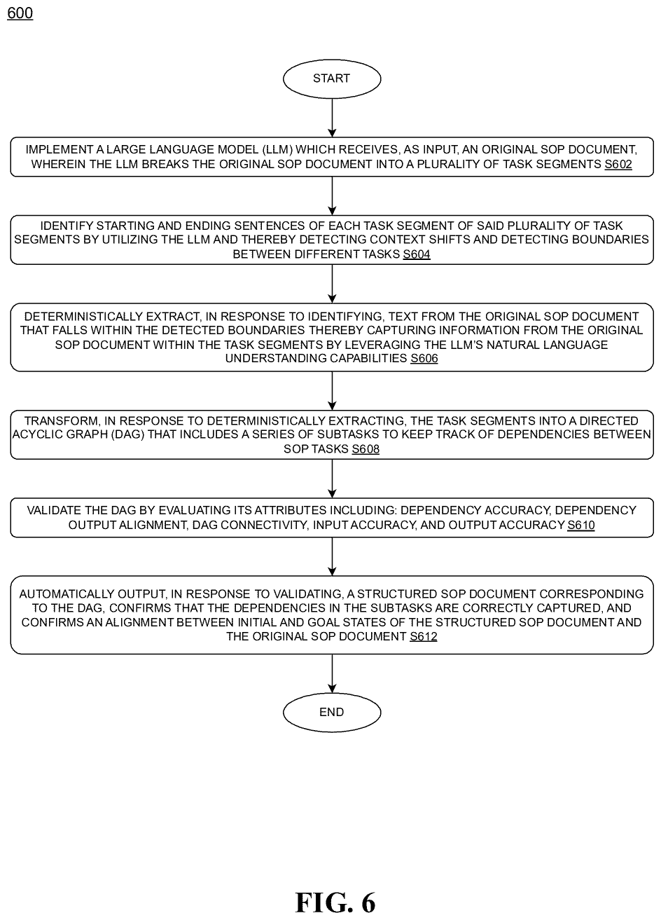

FIG. 6 illustrates a flow chart of a process 600 implemented by the platform, language, database, and cloud agnostic ASRM 406 of FIG. 4 for transforming an unstructured document describing an arbitrarily long SOP into a structured format defining the SOP steps as sub-tasks, their dependencies (interconnection between SOP steps), inputs, and outputs, composing the SOP in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include implementing a model leveraging an LLM which receives, as input, an original SOP document, wherein the LLM breaks the original SOP document into a plurality of task segments. The LLM may be the same or similar to the LLM 407 as disclosed with reference to FIG. 4. Moreover, the original SOP document may be the same or similar to the SOP document 501 as disclosed with reference to FIG. 5. And the LLM 407 may utilize the segmentation module 503 as disclosed with reference to FIG. 5 to segment the SOP document 501 into a plurality of task segments, e.g., segment 1 505(1)-segment n 505(n).

At step S604, the process 600 may include identifying starting and ending sentences of each task segment of said plurality of task segments by utilizing the LLM and thereby detecting context shifts and detecting boundaries between different tasks. The LLM may be the same or similar to the LLM 407 as disclosed with reference to FIG. 4. The identifying process implemented by the process 600 may be the same or similar to the identifying process implemented by the identifying module 414 as disclosed above with reference to FIG. 4.

At step S606, the process 600 may include deterministically extracting, in response to identifying, text from the original SOP document that falls within the detected boundaries thereby capturing information from the original SOP document within the task segments by leveraging the LLM's natural language understanding capabilities. The extracting process implemented by the process 600 may be the same or similar to the extracting process implemented by the extracting module 418 as disclosed above with reference to FIG. 4.

At step S608, the process 600 may include transforming, in response to deterministically extracting, the task segments into a DAG that includes a series of subtasks to keep track of dependencies between SOP tasks (may also be referred to as steps) and retain sequential aspect of the SOP execution. The transforming process implemented by the process 600 may be the same or similar to the transforming process implemented by the transforming module 420 as disclosed above with reference to FIG. 4. The DAG may be the same or similar to the DAG 509(1)-DAG 509(n) as disclosed above with reference to FIG. 5. In some embodiments, in the process 600, each subtask may be represented as a node of the DAG, and dependencies between the subtasks may be represented as links or edges between the nodes. Examples of DAGs having a node and links or edges between the nodes have been described above with reference to FIG. 5.

At step S610, the process 600 may include validating the DAG by evaluating the following attributes: dependency accuracy, dependency output alignment, DAG connectivity, input accuracy, and output accuracy. The validating process implemented by the process 600 may be the same or similar to the validating process implemented by the validating module 422 as disclosed above with reference to FIG. 4. For example, in validating the DAG (i.e., the DAG 509(1)-509(n) as disclosed above with reference to FIG. 5) by evaluating the dependency accuracy attribute, the process 600 may further include comparing an input of each subtask with its list of dependencies, i.e., interconnection between SOP tasks.

For example, the step S610 of the process 600 may further include: validating the DAG when it is determined, based on comparing, that the input originates from a subtask that is listed as a dependency. Alternatively, in some embodiments, the step S610 of the process 600 may further include invalidating the DAG when it is determined, based on comparing, that the input originates from a subtask that is not listed as a dependency. In some embodiments, in validating the DAG by evaluating the dependency output alignment attribute, the step S610 of the process 600 may further include comparing inputs required by each subtask with outputs generated by other subtasks. Tasks and subtasks with reference to step S610 may be the same or similar to the tasks and subtasks as disclosed above with reference to FIGS. 4 and 5.

In some embodiments, the step S610 of the process 600 may further include validating the DAG when it is determined, based on comparing, that suitable mapping exists between the inputs and the outputs. Moreover, the step S610 of the process 600 may further include invalidating the DAG when it is determined, based on comparing, that no suitable mapping exists between the inputs and the outputs.

In some embodiments, in validating the DAG by evaluating the DAG connectivity attribute, step S610 of the process 600 may further include traversing DAG, by implementing a classical planning technique as disclosed above with reference to FIG. 4, to verify that there exists a path between the initial state and the goal state within the DAG. Initial state and the goal state may be same or similar to the initial state and the goal state, respectively, as disclosed above with reference to FIG. 5. In addition, in some embodiments, in validating the DAG by evaluating the input accuracy attribute, the step S610 of the process 600 may further include comparing input information of the DAG with input information specified in the original SOP document, i.e., SOP document 501 as disclosed above with reference to FIG. 5.

In some embodiments, the step S610 of the process 600 may further include validating the DAG when it is determined, based on comparing, that the input information of the DAG accurately reflects the input information specified in the original SOP document. Alternatively, in some embodiments, step S610 of the process 600 may further include invalidating the DAG when it is determined, based on comparing, that the input information of the DAG does not accurately reflect the input information specified in the original SOP document, i.e., SOP document 501 as disclosed above with reference to FIG. 5.

Moreover, in some embodiments, in validating the DAG by evaluating the output accuracy attribute, the step S610 of the process 600 may further include comparing output information generated by the DAG with output information specified in the original SOP document, i.e., SOP document 501 as disclosed above with reference to FIG. 5.

Additionally, in some embodiments, the step S610 of the process 600 may further include validating the DAG when it is determined, based on comparing, that the output information generated by the DAG accurately reflects the output information specified in the original SOP document, i.e., SOP document 501 as disclosed above with reference to FIG. 5.

In some embodiments, the step S610 of the process 600 may further include invalidating the DAG when it is determined, based on comparing, that the output information generated by the DAG does not accurately reflect the output information specified in the original SOP document, i.e., SOP document 501 as disclosed above with reference to FIG. 5.

At step S612, the process 600 may include automatically outputting, in response to validating, a structured SOP document corresponding to the DAG, confirms that all the dependencies in the subtasks are correctly captured, and confirms an alignment between initial and goal states of the structured SOP document and the original SOP document. The automatically outputting process implemented by the process 600 at step S612 may be the same or similar to the automatically outputting process implemented by the ASRM 406 utilizing the GUI 432 as disclosed above with reference to FIG. 4. For example, some embodiments, the step 612 of the process 600 may further include outputting, for each of the subtasks, a corresponding category identifying corresponding type of each of the subtasks whether a subtask is a decision step, an action to execute, or domain specific knowledge. The subtasks may be the same or similar to the subtasks as disclosed above with reference to FIGS. 4 and 5.

In some embodiments, the ASRD 402 may include a memory (e.g., a memory 106 as illustrated in FIG. 1) which may be a non-transitory computer readable medium that may be configured to store instructions for implementing a platform, language, database, and cloud agnostic ASRM 406 for implementing LLMs and classical planning technique to process complex SOPs to make them machine understandable and transform an unstructured document describing an arbitrarily long SOP, into a structured format defining the SOP steps as sub-tasks, their dependencies (interconnection between SOP steps), inputs, and outputs, composing the SOP as disclosed herein. The ASRD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ASRM 406 or within the ASRD 402, may be used to perform one or more of the processes as described herein. In a particular embodiment, the instructions may reside completely, or at least partially, within the memory 106, the medium reader 112, and/or the processor 104 (see FIG. 1) during execution by the ASRD 402.

In some embodiments, the instructions, when executed, may cause a processor embedded within the ASRM 406 or the ASRD 402 to perform the following: implementing a model leveraging an LLM which receives, as input, an original SOP document, wherein the LLM breaks the original SOP document into a plurality of task segments; identifying starting and ending sentences of each task segment of said plurality of task segments by utilizing the LLM and thereby detecting context shifts and detecting boundaries between different tasks; deterministically extracting, in response to identifying, text from the original SOP document that falls within the detected boundaries thereby capturing information from the original SOP document within the task segments by leveraging the LLM's natural language understanding capabilities; transforming, in response to deterministically extracting, the task segments into a DAG that includes a series of subtasks to keep track of dependencies between SOP tasks; validating the DAG by evaluating its attributes including: dependency accuracy, dependency output alignment, DAG connectivity, input accuracy, and output accuracy; and automatically outputting, in response to validating, a structured SOP document corresponding to the DAG, confirms that the dependencies in the subtasks are correctly captured, and confirms an alignment between initial and goal states of the structured SOP document and the original SOP document. In some embodiments, the processor may be the same or similar to the processor 104 as illustrated in FIG. 1 or the processor embedded within the ASRD 202, ASRD 302, ASRD 402, and ASRM 406 which may be the same or similar to the processor 104.

In some embodiments, the instructions, when executed, may cause the processor 104 to further perform the following: outputting, for each of said subtasks, a corresponding category identifying corresponding type of each of said subtasks whether a subtask is a decision step, an action to execute, or domain specific knowledge, wherein each subtask may be represented as a node of the DAG, and dependencies between the subtasks may be represented as links or edges between the nodes.

In some embodiments, in validating the DAG by evaluating the dependency accuracy attribute, the instructions, when executed, may cause the processor 104 to further perform the following: comparing an input of each subtask with its list of dependencies.

In some embodiments, the instructions, when executed, may cause the processor 104 to further perform the following: validating the DAG when it is determined, based on comparing, that the input originates from a subtask that is listed as a dependency.

In some embodiments, the instructions, when executed, may cause the processor 104 to further perform the following: invalidating the DAG when it is determined, based on comparing, that the input originates from a subtask that is not listed as a dependency.

In some embodiments, in validating the DAG by evaluating the dependency output alignment attribute, the instructions, when executed, may cause the processor 104 to further perform the following: comparing inputs required by each subtask with outputs generated by other subtasks.

In some embodiments, the instructions, when executed, may cause the processor 104 to further perform the following: validating the DAG when it is determined, based on comparing, that suitable mapping exists between the inputs and the outputs.

In some embodiments, the instructions, when executed, may cause the processor 104 to further perform the following: invalidating the DAG when it is determined, based on comparing, that no suitable mapping exists between the inputs and the outputs.

In some embodiments, in validating the DAG by evaluating the DAG connectivity attribute, the instructions, when executed, may cause the processor 104 to further perform the following: traversing DAG, by implementing a classical planning technique, to verify that there exists a path between the initial state and the goal state within the DAG.

In some embodiments, in validating the DAG by evaluating the input accuracy attribute, the instructions, when executed, may cause the processor 104 to further perform the following: comparing input information of the DAG with input information specified in the original SOP document.

In some embodiments, the instructions, when executed, may cause the processor 104 to further perform the following: validating the DAG when it is determined, based on comparing, that the input information of the DAG accurately reflects the input information specified in the original SOP document.

In some embodiments, the instructions, when executed, may cause the processor 104 to further perform the following: invalidating the DAG when it is determined, based on comparing, that the input information of the DAG does not accurately reflect the input information specified in the original SOP document.

In some embodiments, in validating the DAG by evaluating the output accuracy attribute, the instructions, when executed, may cause the processor 104 to further perform the following: comparing output information generated by the DAG with output information specified in the original SOP document.

In some embodiments, the instructions, when executed, may cause the processor 104 to further perform the following: validating the DAG when it is determined, based on comparing, that the output information generated by the DAG accurately reflects the output information specified in the original SOP document.

In some embodiments, the instructions, when executed, may cause the processor 104 to further perform the following: invalidating the DAG when it is determined, based on comparing, that the output information generated by the DAG does not accurately reflect the output information specified in the original SOP document.

In some embodiments as disclosed above in FIGS. 1-6, technical improvements effected by the instant disclosure may include a platform for implementing a platform, language, database, and cloud agnostic automated structure retrieval module configured to transform an unstructured document describing an arbitrarily long SOP into a structured format defining the SOP steps as sub-tasks, their dependencies (interconnection between SOP steps), inputs, and outputs, composing the SOP, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automated structure retrieval of complex standard operating procedures (SOPs) by utilizing one or more processors along with allocated memory, the method comprising:
implementing a model leveraging a Large Language model (LLM) which receives, as input, an original SOP document, wherein the LLM breaks the original SOP document into a plurality of task segments;
identifying starting and ending sentences of each task segment of said plurality of task segments by utilizing the LLM and thereby detecting context shifts and detecting boundaries between different tasks;
deterministically extracting, in response to identifying, text from the original SOP document that falls within the detected boundaries thereby capturing information from the original SOP document within the task segments by leveraging the LLM's natural language understanding capabilities;
transforming, in response to deterministically extracting, the task segments into a Directed Acyclic Graph (DAG) that includes a series of subtasks to keep track of dependencies between SOP tasks ;
validating the DAG by evaluating its attributes including: dependency accuracy, dependency output alignment, DAG connectivity, input accuracy, and output accuracy; and
automatically outputting, in response to validating, a structured SOP document corresponding to the DAG, confirms that the dependencies in the subtasks are correctly captured, and confirms an alignment between initial and goal states of the structured SOP document and the original SOP document.

2. The method according to claim 1, wherein each subtask is represented as a node of the DAG, and dependencies between the subtasks are represented as links or edges between the nodes.

3. The method according to claim 1, further comprising:
outputting, for each of said subtasks, a corresponding category identifying corresponding type of each of said subtasks whether a subtask is a decision step, an action to execute, or domain specific knowledge.

4. The method according to claim 1, wherein in validating the DAG by evaluating the dependency accuracy attribute, the method further comprising:
comparing an input of each subtask with its list of dependencies.

5. The method according to claim 4, further comprising:
validating the DAG when it is determined, based on comparing, that the input originates from a subtask that is listed as a dependency.

6. The method according to claim 4, further comprising:
invalidating the DAG when it is determined, based on comparing, that the input originates from a subtask that is not listed as a dependency.

7. The method according to claim 1, wherein in validating the DAG by evaluating the dependency output alignment attribute, the method further comprising:
comparing inputs required by each subtask with outputs generated by other subtasks.

8. The method according to claim 7, further comprising:
validating the DAG when it is determined, based on comparing, that suitable mapping exists between the inputs and the outputs.

9. The method according to claim 7, further comprising:
invalidating the DAG when it is determined, based on comparing, that no suitable mapping exists between the inputs and the outputs.

10. The method according to claim 1, wherein in validating the DAG by evaluating the DAG connectivity attribute, the method further comprising:
traversing DAG, by implementing a classical planning technique, to verify that there exists a path between the initial state and the goal state within the DAG.

11. The method according to claim 1, wherein in validating the DAG by evaluating the input accuracy attribute, the method further comprising:
comparing input information of the DAG with input information specified in the original SOP document.

12. The method according to claim 11, further comprising:
validating the DAG when it is determined, based on comparing, that the input information of the DAG accurately reflects the input information specified in the original SOP document.

13. The method according to claim 11, further comprising:
invalidating the DAG when it is determined, based on comparing, that the input information of the DAG does not accurately reflect the input information specified in the original SOP document.

14. The method according to claim 1, wherein in validating the DAG by evaluating the output accuracy attribute, the method further comprising:
comparing output information generated by the DAG with output information specified in the original SOP document.

15. The method according to claim 14, further comprising:
validating the DAG when it is determined, based on comparing, that the output information generated by the DAG accurately reflects the output information specified in the original SOP document.

16. The method according to claim 14, further comprising:
invalidating the DAG when it is determined, based on comparing, that the output information generated by the DAG does not accurately reflect the output information specified in the original SOP document.

17. A system for automated structure retrieval of complex standard operating procedures (SOPs), the system comprising:
a processor; and
a memory operatively connected to the processor via a communication interface, the memory storing computer readable instructions, when executed, causes the processor to:
implement a model leveraging a Large Language model (LLM) which receives, as input, an original SOP document, wherein the LLM breaks the original SOP document into a plurality of task segments;
identify starting and ending sentences of each task segment of said plurality of task segments by utilizing the LLM and thereby detecting context shifts and detecting boundaries between different tasks;
deterministically extract, in response to identifying, text from the original SOP document that falls within the detected boundaries thereby capturing information from the original SOP document within the task segments by leveraging the LLM's natural language understanding capabilities;
transform, in response to deterministically extracting, the task segments into a Directed Acyclic Graph (DAG) that includes a series of subtasks to keep track of dependencies between SOP tasks;
validate the DAG by evaluating its attributes including: dependency accuracy, dependency output alignment, DAG connectivity, input accuracy, and output accuracy; and
automatically output, in response to validating, a structured SOP document corresponding to the DAG, confirms that the dependencies in the subtasks are correctly captured, and confirms an alignment between initial and goal states of the structured SOP document and the original SOP document.

18. The system according to claim 17, wherein each subtask is represented as a node of the DAG, and dependencies between the subtasks are represented as links or edges between the nodes.

19. The method according to claim 17, wherein the processor is further configured to:
output, for each of said subtasks, a corresponding category identifying corresponding type of each of said subtasks whether a subtask is a decision step, an action to execute, or domain specific knowledge.

20. A non-transitory computer readable medium configured to store instructions for automated structure retrieval of complex standard operating procedures (SOPs), the instructions, when executed, cause a processor to perform the following:
implementing a model leveraging a Large Language model (LLM) which receives, as input, an original SOP document, wherein the LLM breaks the original SOP document into a plurality of task segments;
identifying starting and ending sentences of each task segment of said plurality of task segments by utilizing the LLM and thereby detecting context shifts and detecting boundaries between different tasks;
deterministically extracting, in response to identifying, text from the original SOP document that falls within the detected boundaries thereby capturing information from the original SOP document within the task segments by leveraging the LLM's natural language understanding capabilities;
transforming, in response to deterministically extracting, the task segments into a Directed Acyclic Graph (DAG) that includes a series of subtasks to keep track of dependencies between SOP tasks;
validating the DAG by evaluating its attributes including: dependency accuracy, dependency output alignment, DAG connectivity, input accuracy, and output accuracy; and
automatically outputting, in response to validating, a structured SOP document that confirms connectivity of the structured SOP document corresponding to the DAG, confirms that the dependencies in the subtasks are correctly captured, and confirms an alignment between initial and goal states of the structured SOP document and the original SOP document.
